(19) United States
(12) Patent Application Publication
(10) Pub. No.: US 2020/0362843 A1
(43) Pub. Date: Nov. 19, 2020

(54) ELECTRIC COMPRESSOR

(71) Applicant: LG Electronics Inc., Seoul (KR)

(72) Inventors: Namsik YIM, Seoul (KR); Taekyoung KIM, Seoul (KR); Yicheol CHOI, Seoul (KR); Sanghoon NAM, Seoul (KR)

(73) Assignee: LG Electronics Inc., Seoul (KR)

(21) Appl. No.: 16/794,980

(22) Filed: Feb. 19, 2020

(30) Foreign Application Priority Data
May 17, 2019 (KR) 10-2019-0058246

(51) Int. Cl. F04B 35/04; F04C 18/02; H02M 7/48

(52) U.S. Cl. CPC F04B 35/04; F05B 2210/12; H02M 7/48; F04C 18/0215

(57) ABSTRACT

An electric compressor is provided, comprising a compression part comprising a fixed scroll and an orbiting scroll, a motor part coupled to the compression part and configured to apply a rotation force to the compression part, and an inverter part electrically coupled to the motor part and configured to apply power and control signals to the motor part. The inverter part comprises a power supply element housed therein and configured to apply power to the motor part, and a printed circuit board (PCB) electrically coupled to the power supply element and configured to apply a control signal to the motor part. The insulation member is located on one side of the power supply element adjacent to the PCT, and the insulation member is configured to shield the one side of the power supply element and prevent noise generated in the power supply element from reaching the PCB.

### CROSS-REFERENCE TO RELATED APPLICATION

This application claims the benefit of priority under 35 U.S.C. § 119(a) to Korean Patent Application No. 10-2019-0058246, filed on May 17, 2019, the disclosure of which is incorporated by reference herein in its entirety.

### BACKGROUND

### 1. Technical Field

The present disclosure relates to an electric compressor, and more particularly, to an electric compressor capable of having an additional element in a space between an inverter device of an inverter part and a printed circuit board by shield electromagnetic waves generated from the inverter device.

### 2. Description of the Related Art

Compressors serving to compress refrigerant in air conditioning systems for vehicle have been developed in various forms. In recent years, electric compressors (motor-operated compressors) driven by electric power using motors have been actively developed according to the tendency of electrification of vehicle components.

A motor-operated compressor generally employs a scroll-compression method which is suitable for a high compression ratio operation. Such a scroll-type motor-operated compressor (hereinafter, referred to as “motor-operated compressor”) includes a motor part, a compression part, and a rotating shaft connecting the motor part and the compression part.

Specifically, the motor part is configured as a rotary motor or the like, and installed inside a hermetic casing. The compression part is located on one side of the motor part, and is provided with a fixed scroll and an orbiting scroll. The rotating shaft is configured to transmit rotational force of the motor part to the compression part.

An electric part is configured to receive power and a control signal from an inverter device housed in an inverter part. The inverter part is electrically connected to the outside and is configured to receive power and a control signal necessary to drive the electric part.

Recently, a compression ratio, a compression amount, and the like of refrigerant compressed in the compression part are increased, and thus a trend of high-voltage power being applied to the electric part is spreading. In order to apply a high voltage to the electric part, the inverter part that receive power and a control signal from the outside should be increased in size. That is, the rated capacity of the inverter device should be increased, and the size of the inverter part for accommodating the inverter device is also increased.

On the contrary, a compressor provided in a vehicle air conditioning system is advantageously miniaturized. This is because vehicles are based on the premise of movement such that, as a compressor and an air conditioning system including the same become smaller, it is more advantageous to provide the compressor and the air conditioning system in vehicles.

The application of high voltage power necessarily entails an increase in the size of an inverter device or the like. Also, a miniaturized inverter device capable of receiving high-voltage power is expensive and disadvantageous in terms of economy. Accordingly, it is preferable to efficiently use a space inside an inverter part in which an inverter device is to be provided.

However, since high-voltage power is applied, electromagnetic noise generated in inverter devices, printed circuit boards and the like is increased. To prevent interference due to noise, devices such as inverter devices and printed circuit boards should be spaced a sufficient distance apart from each other for the purpose of insulation. This can lead to an increase in size throughout the inverter part.

Furthermore, in order to process high voltage power and control signals, a printed circuit board for processing the signals must be increased in size. In order to prevent an increase in the size of a printed circuit board, a printed circuit board or electronic element for performing a corresponding function must be additionally provided.

However, there is not enough space inside the inverter part for the additional printed circuit board or the additional inverter element to be provided. This is due to the fact that the devices must be spaced a sufficient distance apart from each other in order to ensure a sufficient insulation distance as described above.

Korean Patent No. 10-1069663 discloses an electric compressor equipped with an inverter. In detail, there is provided an electric compressor having a structure capable of improving an insulation effect between an inverter device and a cover by including an insulation member in a space where the inverter device is to be housed.

However, this type of electric compressor can achieve the purpose of insulation of an inverter device, but has a limitation in that there is no consideration for a method of reducing the size of an inverter housing in which an inverter device is to be housed.

Moreover, this document discloses a method of entirely filling a space between the inverter device and the cover with an insulating member. Thus, the inverter housing may be rather increased in size.

Korean Patent Publication No. 10-201 6-0041 453 discloses an electric compressor equipped with an inverter. In detail, there is disclosed an electric compressor having a structure capable of preventing damage to an insulation sheet by fastening a washer when coupling a bolt for fastening the insulation sheet.

However, this type of electric compressor can prevent damage to an insulation sheet, but has a limitation in that there is no consideration for a means for preventing an increase in the overall size of an inverter part due to the application of a high voltage.

### PRIOR ART DOCUMENTS

### Patent Documents

(Patent Document 1) Korean Patent No. 10-1069663 (Oct. 5, 2011)

(Patent Document 2) Korean Patent Publication No. 10-2016-0041453 (Apr. 18, 2016)

### SUMMARY

The present disclosure is directed to providing an electric compressor having a structure capable of solving the above-mentioned problems.

First, the present disclosure is directed to providing an electric compressor having a structure capable of receiving high-voltage power without increasing the size of an inverter part.

Also, the present disclosure is directed to providing an electric compressor having a structure that does not need to excessively increase the size of an integrated circuit board even when high-voltage power is applied.

Also, the present disclosure is directed to providing an electric compressor having a structure capable of improving space utilization efficiency in an inverter chamber formed inside an inverter chamber.

Also, the present disclosure is directed to providing an electric compressor having a structure capable of shielding a power supply element to prevent the power supply element from transferring noise to a printed circuit board.

Also, the present disclosure is directed to providing an electric compressor having a structure capable of providing an additional element in a space between a power supply element and a printed circuit board.

Also, the present disclosure is directed to providing an electric compressor having a structure capable of facilitating the grounding of a power supply element without a separate wiring structure.

In order to achieve the above objects, the present disclosure provides an electric compressor comprising a compression part comprising a fixed scroll and an orbiting scroll configured to orbit relative to the fixed scroll to compress refrigerant; a motor part coupled to the compression part and configured to apply a rotational force to the compression part; and an inverter part electrically coupled to the motor part and configured to apply power and control signals to the motor part. The inverter part may comprise a power supply element housed therein and configured to apply power to the motor part; and a printed circuit board (PCB) electrically coupled to the power supply element and configured to apply a control signal to the motor part. An insulation member may be located on one side of the power supply element adjacent to the PCB, and the insulation member may be configured to shield the one side of the power supply element and prevent noise generated in the power supply element from reaching the PCB.

Also, the insulation member of the electric compressor may comprise a first layer formed of a conductive material, wherein the first layer is configured to be brought into contact with the insulation member; and a second layer configured formed of a non-conductive material, wherein the second layer is configured to cover the first layer.

Also, the power supply element and the PCB of the electric compressor may be electrically coupled to each other with a predetermined space formed therebetween, and an additional element may be located in the predetermined space and may be configured to be electrically connected to the PCB.

Also, the additional element of the electric compressor may comprise an additional PCB.

Also, the electric compressor may further comprise a main housing configured to house the compression part and the motor part, wherein the inverter part may include an inverter housing having one side coupled to the main housing; and an inverter cover coupled to the inverter housing with a predetermined space formed therein. The PCB, the power supply element, and the insulation member may be housed in the predetermined space.

Also, the electric compressor may further comprise a heat dissipation member located between the power supply element and the inverter housing. The heat dissipation member may be configured to come into contact with the power supply element and the inverter housing to transfer heat generated in the power supply element to the inverter housing.

Also, the heat dissipation member of the electric compressor may be formed of a conductive material.

Also, the electric compressor may further include a fastening member extending lengthwise and configured to fasten the insulation member, the power supply element, and the heat dissipation member.

Also, the fastening member of the electric compressor may be configured to be inserted through and coupled to the insulation member and the power supply element, and the fastening member may be configured to be inserted into and coupled to the heat dissipation member.

Also, a side surface of the fastening member fastened to the power supply element of the electric compressor may be configured to be brought into electrical contact with the power supply element, and one end of the fastening member fastened to the heat dissipation member may be configured to be brought into electrical contact with the heat dissipation member.

Also, the inverter housing and the heat dissipation member of the electric compressor may be configured to be brought into electrical contact with each other.

Also, the fastening member of the electric compressor may comprise a head part forming one end facing the PCB; and a body part extending from the head part. Another end of the body part opposite to the head part may be configured to be inserted into the heat dissipation member.

Also, the insulation member may comprise a fastening member insertion hole, which may be recessed a predetermined distance to accommodate the head part of the fastening member.

Also, the power supply element may further comprise a fastening hole, and the heat dissipation member may further comprise a coupling hole, which may be recessed a predetermined distance. The fastening member may be configured to be inserted through and coupled to the fastening hole and may be configured to be inserted into and coupled to the coupling hole.

Also, the electric compressor may further comprise a connector part configured to electrically couple the inverter part and the motor part.

According to the present disclosure, the following effects can be obtained.

First, the insulation member may be provided in the power supply element. The insulation member may electrically shield the power supply element to prevent noise generated in the power supply element from being transferred to the printed circuit board.

Also, the power supply element and the printed circuit board may be electrically connected to each other with a space formed therebetween. An additional element may be provided in the space.

The additional element may be provided as an additional printed circuit board. The additional printed circuit board may be configured to perform a function to be performed by the printed circuit board. That is, without increasing the size of the printed circuit board, it may be possible to increase the processing capacity of the printed circuit board.

Accordingly, without increasing the size of the printed circuit board, high-voltage power may be applied to the power supply element. Thus, the application of high-voltage power may be possible without increasing the size of the inverter part housed in the printed circuit board.

Also, the additional element, as an example, the additional printed circuit board may be located between the power source element and the printed circuit board. This can be achieved by the insulation member electrically shielding the power supply element.

Accordingly, there may be no need to provide a separate space for the additional printed circuit board or to rearrange various members provided in the inverter part. As a result, it may be possible to improve space utilization inside the inverter part.

The insulation member may comprise a first layer configured to cover the power supply element and a second layer configured to cover the first layer. The first layer may be formed of a conductive material, and a second layer may be formed of a non-conductive material.

The first layer may absorb noise generated in the power supply element. Also, the second layer may be configured to electrically shield the first layer and may prevent noise from being transferred from the first layer to the printed circuit board.

Also, an additional element, for example, an additional printed circuit board may be provided in a space between the power supply element and the printed circuit board. Accordingly, it may be possible to improve the freedom of arrangement of elements inside the inverter part.

Also, a fastening member configured to fasten the insulation member, the power supply element, and the heat dissipation member may be inserted through and fastened to the insulation member and the power supply element. Also, the fastening member may have one end inserted into and fastened to the heat dissipation member.

In this case, the power supply element and the fastening member may be electrically connected to each other. Also, the fastening member and the heat dissipation member may be electrically connected to each other. Further, the heat dissipation member may be electrically connected to an inverter housing and also a main housing connected to the inverter housing.

Accordingly, the power supply element, the heat dissipation member, the inverter housing, and the main housing may be electrically connected to each other by a fastening member. Accordingly, the power supply element may be grounded by the heat dissipation member, the inverter housing, and the main housing. As a result, it may be possible to ground the power supply element without a separate wiring.

### BRIEF DESCRIPTION OF THE DRAWINGS

FIG. 1 is a perspective view of an electric compressor according to an embodiment of the present disclosure.

FIG. 2 is an exploded perspective view of the electric compressor of FIG. 1 according to an embodiment of the present disclosure.

FIG. 3 is a cross-sectional view of the electric compressor of FIG. 1 according to an embodiment of the present disclosure.

FIG. 4 is an exploded perspective view showing an internal structure of an inverter part provided in the electric compressor of FIG. 1 according to an embodiment of the present disclosure.

FIG. 5 is a perspective view showing an aspect in which an insulation member is provided in a power supply element included in the inverter part of FIG. 4 according to an embodiment of the present disclosure.

FIG. 6A shows a perspective view of the insulation member of FIG. 5 according to an embodiment of the present disclosure.

FIG. 6B shows a plan view of the insulation member of FIG. 5 according to an embodiment of the present disclosure.

FIG. 7 is a perspective view showing an aspect in which an additional element is placed on a printed circuit board to be housed in the inverter part of FIG. 4 according to an embodiment of the present disclosure.

FIG. 8 is a side view showing an aspect in which an additional element is placed on the printed circuit board to be housed in the inverter part of FIG. 4 according to an embodiment of the present disclosure.

FIG. 9 is a plan view showing an aspect in which an additional element is placed on the printed circuit board to be housed in the inverter part of FIG. 4 according to an embodiment of the present disclosure.

FIG. 10 is a rear view showing an aspect in which an additional element is placed on the printed circuit board to be housed in the inverter part of FIG. 4 according to an embodiment of the present disclosure.

FIG. 11 is a side view showing a relationship in which an additional element and a fastening member are coupled to the printed circuit board to be housed in the inverter part of FIG. 4 according to an embodiment of the present disclosure.

### DETAILED DESCRIPTION OF THE EMBODIMENTS

An electric compressor according to an embodiment of the present disclosure will be described below in detail with respect to the accompanying drawings.

In the following description, some elements may be omitted so as to clarify the features of the present disclosure.

It will be understood that when an element is referred to as being “connected with” another element, the element can be connected with another element, or intervening elements may also be present.

In contrast, when an element is referred to as being “directly connected with” another element, there are no intervening elements present.

A singular representation may include a plural representation unless it represents a definitely different meaning from the context.

The term “refrigerant” as used herein refers to any medium that takes heat away from a low-temperature object and transports the heat to a high-temperature object. In an embodiment, the refrigerant may include carbon dioxide (CO2), R134a, R1234yf, and the like.

The term “conductive material” as used herein refers to a material capable of receiving heat or electricity from any member and transferring heat or electricity to another member. In an embodiment, the conductive material may include iron (Fe), copper (Cu), and the like.

The term “insulation” as used herein refers to blocking conduction of electricity or heat. Also, the term “insulating material” as used herein refers to any material having the above-described insulating properties. In an embodiment, the insulating material may be a synthetic resin such as polyethylene (PE).

The term “printed circuit board” (PCB) as used herein refers to a substrate for forming an electronic circuit by fixing electronic components such as an integrated circuit, a resistor, and a condenser to a surface of a printed wiring board and by connecting the components by means of wiring or the like.

The term “inverter element” as used herein refers to an electronic circuit element using semiconductor. In particular, the inverter element may be any electronic circuit element provided in the inverter device for switching direct-current power into alternating-current power.

In an embodiment, an inverter element may refer to a component or device that is provided as a switching element to have a function of opening or closing a circuit without using contact points. In the above embodiment, a semiconductor element may refer to a component or device that is provided as a switching element to have a function of opening or closing a circuit without using contact points.

The term “noise” as used herein refers to any signal for generating a desired signal among electromagnetic signals generated by any device that is operated due to the application of power. That is, “noise” is used as a term to refer to signals other than electromagnetic signals generated by the device to perform its function.

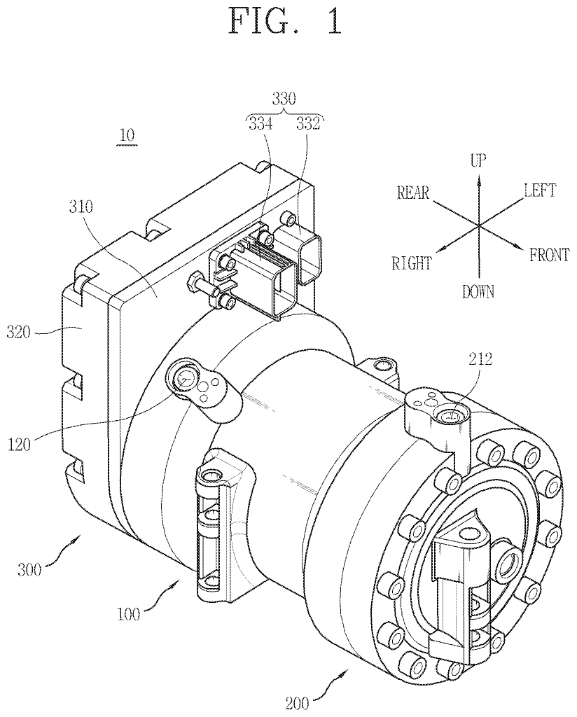

The terms “front,” “rear,” “upper,” “lower,” “right,” and “left” as used herein will be understood with reference to a coordinate system shown in FIG. 1.

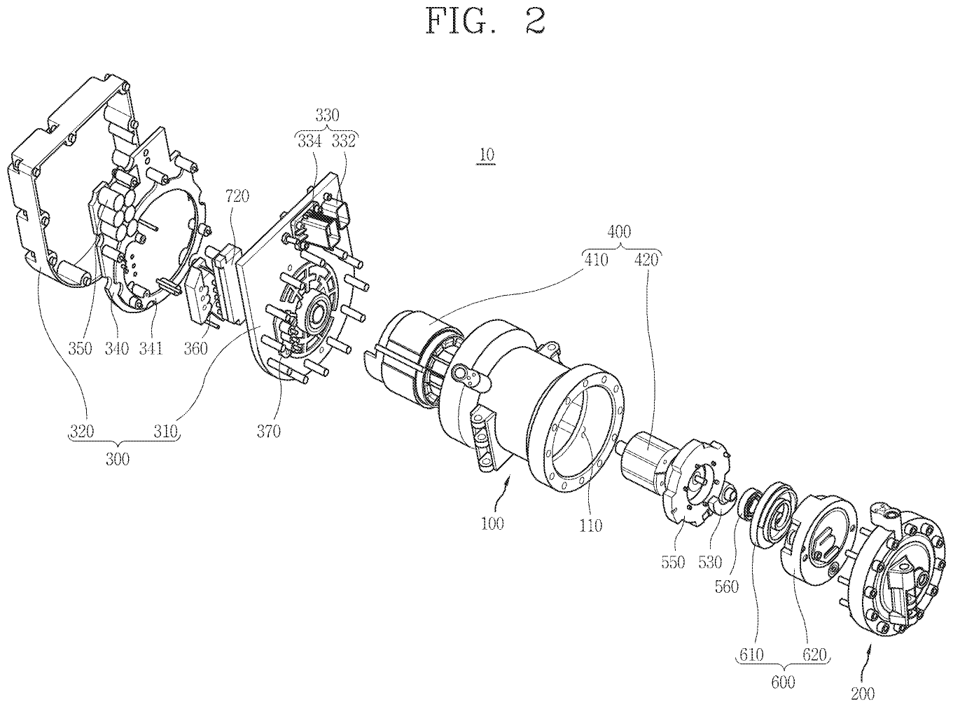

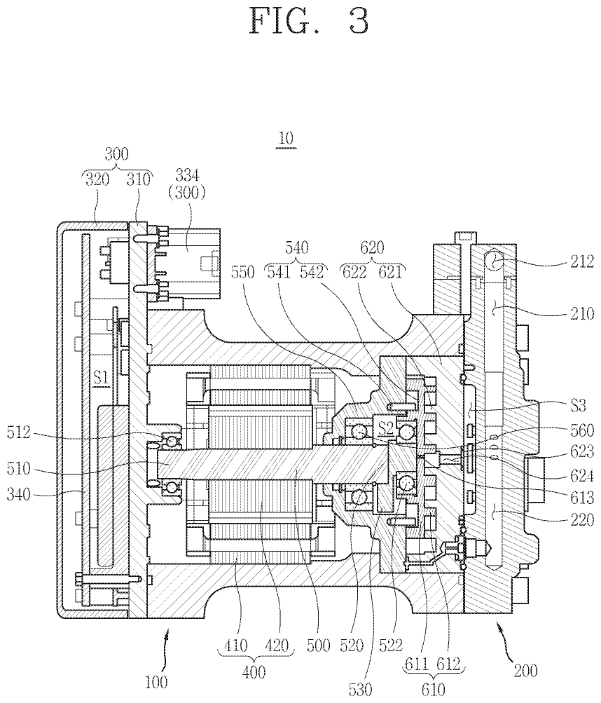

Referring to FIGS. 2 to 4, the electric compressor 10 according to an embodiment of the present disclosure may comprise a main housing 100, a rear housing 200, an inverter part 300, a motor part 400, a rotary shaft part 500, and a compression part 600.

Also, the electric compressor 10 according to an embodiment of the present disclosure may comprise an insulation part 700 for simply forming the internal structure of the inverter part 300.

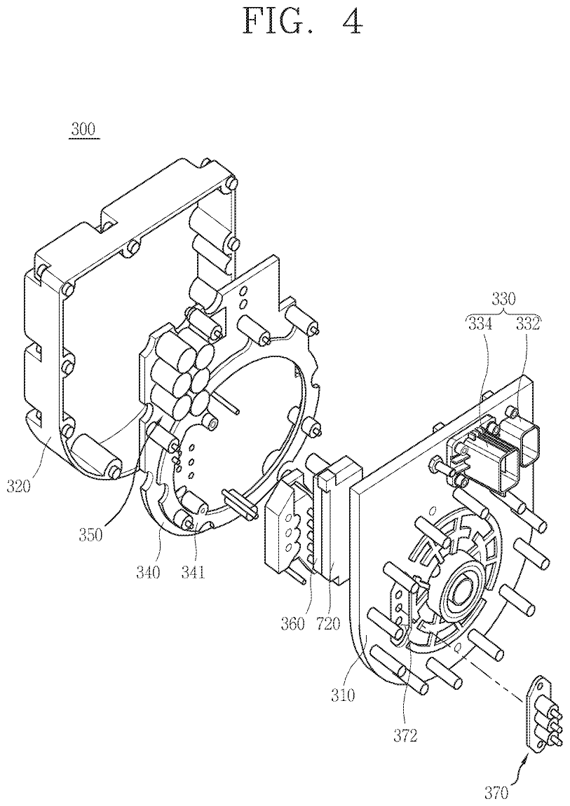

The elements of the electric compressor 10 according to an embodiment of the present disclosure will be described below with reference to FIGS. 4 to 4. However, the insulation part 700 will be described in another section.

The main housing 100 may form the external appearance of the electric compressor 10. Also, the main housing 100 may form the body of the electric compressor 10 and may house various elements for compressing refrigerant. As an example, the motor part 400, the rotary shaft part 500, the compression part 600, and the like may be housed therein.

The main housing 100 may have a cylindrical shape having a circular cross-section and extending lengthwise, that is, in the front-rear direction in the shown embodiment. The shape of the main housing 100 may be changed to any shape capable of housing the motor part 400, the rotary shaft part 500, and the compression part 600.

However, considering that a high pressure is generated inside the main housing 100 along with compression of refrigerant, the main housing 100 may need to have a circular cross-section with high pressure resistance.

The rear housing 200 may be provided on one side of the main housing 100, that is, the front side of the main housing 100 in the shown embodiment. The main housing 100 may communicate with the rear housing 200. Refrigerant compressed in the compression part 600 inside the main housing 100 may flow to the rear housing 200 and then may be discharged to the outside of the electric compressor 10.

The inverter part 300 may be provided on the other side of the main housing 100 facing the rear housing 200, that is, the rear side in the shown embodiment. The inverter part 300 may be configured to apply power and a control signal to a device housed in the main housing 100. The inverter part 300 may be electrically connected to a device housed in the main housing 100.

In an embodiment, the main housing 100 and the inverter part 300 may communicate with each other. Along with the operation of the electric compressor 10, a lot of heat may be generated in a printed circuit board 340, an inverter element 350, a power supply element 360, and the like which are housed in the inverter part 300.

In an embodiment in which the main housing 100 and the inverter part 300 communicate with each other, refrigerant introduced into the main housing 100 may be introduced into an inverter chamber S1 inside the inverter part 300. The introduced refrigerant may cool the printed circuit board 340, the inverter element 350, the power supply element 360, and the like.

The main housing 100 may comprise a motor chamber 110 and an intake port 120.

The motor chamber 110 may be a space where the motor part 400 is to be housed. The motor chamber 110 may be defined as the inner space of the main housing 100. The outer circumferential surface of the motor part 400 housed in the motor chamber 110 may be configured to come into contact with the outer circumferential surface of the motor chamber 110. That is, the outer circumferential surface of the motor part 400 may be brought into contact with the inner circumferential surface of the main housing 100.

The motor chamber 110 may communicate with the intake port 120 and the compression part 600. Refrigerant introduced into the main housing 100 may be introduced into the compression part 600 through the motor chamber 110.

In an embodiment, the motor chamber 110 may be provided as a separate housing (not shown). In the above embodiment, the separate housing (not shown) forming the motor chamber 110 may be housed in the main housing 100. Also, the outer circumferential surface of the housing (not shown) may be configured to come into contact with the inner circumferential surface of the main housing 100.

In an embodiment, a protrusion (not shown) may be formed on the outer circumferential surface of the motor chamber 110, and a blind hole (not shown) may be formed on the outer circumferential surface of a stator 410 by being recessed therefrom. In the above embodiment, the motor part 400 may be housed in the motor chamber 110 such that the protrusion (not shown) can be inserted into the blind hole (not shown).

The intake port 120 may enable the inside and outside of the main housing 100 to communicate with each other. Refrigerant may be introduced into the housing 100 through the intake port 120.

The intake port 120 may be formed in any shape capable of enabling the inside and outside of the main housing 100 to communicate with each other. In an embodiment, the intake port 120 may be formed as a through-hole that passes through the main housing 100.

In the shown embodiment, the intake port 120 may be located adjacent to the rear side of the outer circumferential surface of the main housing 100, that is, adjacent to the inverter part 300. This may be to allow refrigerant introduced through the intake port 120 to exchange heat with the inverter part 300. Accordingly, the printed circuit board 340, the inverter element 350, the power supply element 360, and the like may be cooled by the refrigerant.

The refrigerant introduced into the main housing 100 through the intake port 120 may be compressed in the compression part 600 and then may be discharged through an exhaust port 212.

The rear housing 200 may form a portion of the external appearance of the electric compressor 10. Also, the rear housing 200 may comprise a flow path through which refrigerant and oil can flow and also comprise the exhaust port 212 for discharging refrigerant to the outside.

The rear housing 200 may be located on one side of the main housing 100, that is, the front side in the shown embodiment. The rear housing 200 and the main housing 100 may be configured to communicate with each other. The refrigerant compressed in the compression part 600 inside the main housing 100 may be introduced into the rear housing 200.

The rear housing 200 may be provided in the shape of a cap having a circular cross-section. The rear housing 200 may be coupled to the main housing 100 such that the main housing 100 is sealed.

The rear housing 200 and the main housing 100 may be coupled to each other with a predetermined space formed therebetween. The predetermined space may be defined as a discharge chamber S3. The refrigerant compressed in the compression part 600 may pass through the discharge chamber S3 such that the pressure of the refrigerant drops to a predetermined pressure before the refrigerant is introduced into the rear housing 200.

The rear housing 200 may comprise an exhaust flow path 210 and an oil flow path 220.

The exhaust flow path 210 may be a passage through which the refrigerant compressed in the compression part 600 can flow to be discharged to the outside. In the shown embodiment, the exhaust flow path 210 may be formed inside the rear housing 200 in the vertical direction. This may be due to a tendency of the compressed refrigerant to move upward by a density difference.

An oil separation device (not shown) may be provided on the exhaust flow path 210. The oil separation device (not shown) may be configured to separate oil mixed with the compressed refrigerant. In an embodiment, the oil separation device (not shown) may be configured to centrifugally separate oil.

The exhaust port 212 may be formed on one end of the exhaust flow path 210, that is, an upper end in the shown embodiment. The exhaust port 212 may enable the inside and outside of the rear housing 200 to communicate with each other. In detail, the exhaust port 212 may enable the exhaust flow path 210 and the outside of the rear housing 200 to communicate with each other.

Refrigerant may be discharged to the outside of the rear housing 200 through the exhaust port 212.

The exhaust port 212 may be formed in any shape capable of enabling the inside and outside of the rear housing 200 to communicate with each other. In an embodiment, the exhaust port 212 may be formed as a through-hole that passes through the inner circumference and outer circumference of the rear housing 200.

The refrigerant discharged from the exhaust port may selectively pass through an oil separator (not shown) and then flow into a condenser (not shown) to undergo a condensation process.

The oil flow path 220 may be a passage through which the oil separated from the refrigerant flows. In the shown embodiment, the oil flow path 220 may be formed inside the rear housing 200 in the vertical direction. Also, the oil flow path 220 may be located below the exhaust flow path 210. This may be due to a tendency of the separated oil to move downward by a density difference.

The oil flow path 220 may communicate with the exhaust flow path 210. Also, the oil flow path 220 may communicate with the rotary shaft part 500 and the compression part 600. Oil moved to a lower side of the rear housing 200 through the oil flow path 220 may be discharged through an oil discharge port (not shown).

The discharged oil may be transferred back to the rotary shaft part 500 and the compression part 600 to reduce heat, friction or the like generated during the compression of refrigerant. The oil transfer process may be performed by a means capable of applying a conveying force to the oil, such as an oil pump (not shown).

The inverter part 300 may apply power and a control signal to a device housed in the main housing 100, that is, the motor part 400. The inverter part 300 may be electrically connected to the device housed in the main housing by a conductive line (not shown) or a connector unit 390.

The inverter part 300 may receive power and a control signal from an external controller (not shown). The inverter part 300 may be electrically connected to the external controller (not shown).

The inverter part 300 may receive direct-current power from the outside. The inverter part 300 may be configured to convert the received direct-current power into alternating-current power. In an embodiment, the inverter part 300 may convert the direct-current power into three-phase power having U, V, and W phases.

The inverter part 300 may communicate with the main housing 100. Refrigerant introduced into the main housing 100 may be introduced into the inverter chamber S1 in the inverter part 300. The introduced refrigerant may directly cool an inverter device (not shown) and the like.

The inverter part 300 may comprise an inverter housing 310, an inverter cover 320, a connector module 330, a printed circuit board 340, an inverter element 350, a power supply element, and a connector unit 370.

The inverter housing 310 may form a portion of the outside of the inverter part 300. The inverter housing 310 may be located adjacent to the main housing 100. The inverter housing 310 may be a part where the inverter part 300 is coupled to the main housing 100.

The connector module 330 may be provided on one side of the inverter housing 310, that is, on the front side in the shown embodiment. Also, a connector connecting part 392 to which the connector unit 390 can be electrically connected may be formed on the one side of the inverter housing 310.

In an embodiment, the inverter housing 310 may communicate with the main housing 100. In the above embodiment, the refrigerant introduced into the main housing 100 may be introduced into the inverter chamber S1 to directly cool the inverter device (not shown).

The inverter cover 320 may be coupled to the other side of the inverter housing 310 opposite to the one side, that is, to the rear side in the shown embodiment. The inverter housing 310 and the inverter cover 320 may be coupled to each other with a predetermined space formed therebetween.

The inverter chamber S1 may be defined by the predetermined space. The printed circuit board 340, the inverter element 350, and the power supply element 360 may be housed in the inverter chamber S1.

Also, an additional element housing part 740 may be formed between the printed circuit board 340 and the power supply element 360 in the inverter chamber S1. An additional element 750 may be housed in the additional element housing part 740.

The inverter cover 320 may form the outside of the inverter part 300 along with the inverter housing 310. The inverter cover 320 may be coupled to the inverter housing 310 with a predetermined space formed therebetween. As described above, the predetermined space may be defined as the inverter chamber S1.

The inverter cover 320 may be located on one side of the inverter housing 310 opposite to the main housing 100, that is, on the rear side in the shown embodiment. The inverter cover 320 may be coupled to the inverter housing 310 by a separate fastening means (not shown).

The connector module 330 may be a part where the inverter part 300 is electrically connected to an external controller (not shown). A connector (not shown) may be electrically connected to the connector module 330. Thus, power and a control signal applied from the external controller (not shown) may be transferred to the inverter part 300.

The power and control signal received by the connector module 330 may be processed by the printed circuit board 340, the inverter element 350, the power supply element 360, the additional element 380, and the like. The processed power and control signal may be transferred to the motor part 400. The motor part 400 may be driven by the transferred power and control signal to generate a rotational force for rotating the compression part 600.

In the shown embodiment, the connector module 330 may be located on a front upper side of the inverter housing 310. The location of the connector module 330 may be changed to any location capable of being electrically connected to the external controller (not shown).

The connector module 330 may comprise a communication connector 332 and a power connector 334. The communication connector 332 may be configured to receive a control signal. The power connector 334 may be configured to receive a power signal.

Alternatively, the connector module 330 may be provided as a single connector. In the above embodiment, the single connector may be configured to receive both of the power and control signals.

The printed circuit board (PCB) 340 may generate a control signal for controlling the motor part 400 along with the inverter element 350. The printed circuit board 340 may be electrically connected to the connector module 330, the inverter element 350, the power supply element 360, and the additional element 380.

The printed circuit board 340 and the inverter element 350 may be configured to generate a control signal for controlling the motor part 400 using the control signal transferred through the connector module 330.

The control signal generated by the printed circuit board 340 and the inverter element 350 may be transferred to the motor part 400 by the connector unit 390.

The printed circuit board 340 may comprise an inverter bracket 341. The inverter bracket 341 may be located on one side of the printed circuit board 340 facing the inverter housing 310.

The inverter bracket 341 may couple the printed circuit board 340 to the inverter housing 310. Also, the inverter bracket 341 may keep the printed circuit board 340 spaced a predetermined distance from the inverter housing 310.

The inverter element 350 may generate a control signal for controlling the motor part 400 along with the printed circuit board 340. The inverter element 350 may be electrically connected to the printed circuit board 340, the power supply element 360, and the additional element 380.

The inverter element 350 may be provided in any form capable of computation of a control signal along with the printed circuit board 340. In an embodiment, the inverter element 350 may be provided as silicon carbide (SIC), gallium nitride (GaN), an insulated gate bipolar transistor (IGBT), an insulated gate bipolar transistor (IGBT), a metal-oxide-semiconductor field-effect transistor (MOSFET), or the like.

The power supply element 360 may generate a power signal for driving the motor part 400. The power supply element 360 may be electrically connected to the connector module 330, the printed circuit board 340, the inverter element 350, and the additional element 380.

The power supply element 360 may be configured to generate a power signal for driving the motor part 400 using the power signal transferred through the connector module 330.

The power signal generated by the power supply element 360 may be transferred to the motor part 400 by the connector unit 390.

A heat dissipation member 720 of the insulation part 700 may be brought into contact with one side of the power supply element 360 facing the inverter housing 310. Also, an insulation member 710 of the insulation part 700 may be brought into contact with one side of the power supply element 360 facing the inverter cover 320.

The insulation part 700 may prevent electromagnetic noise generated in the power supply element 360 from being transferred to the printed circuit board 340. Also, heat generated in the power supply element 360 may be effectively dissipated. This will be described in detail below.

In the shown embodiment, the power supply element 360 may have a rectangular parallelepiped shape extending in the length direction. A connection pin 361 may be provided on both side surfaces in the length direction of the power supply element 360.

The connection pin (361) may electrically connect the power supply element 360 and the printed circuit board 340. The connection pin 361 may be formed to extend toward the printed circuit board 340.

The connection pin 361 may be electrically inserted into an electrical hole (not shown) formed on the printed circuit board 340.

A fastening hole 362 may be a space to which a fastening member 730 of the insulation part 700 can be coupled. The fastening hole 362 may be formed through the power supply element 360 in the height direction. In other words, the fastening hole 362 may be formed to extend from one side of the power supply element 360 where the insulation member 710 can be provided to the other side of the power supply element 360 where the heat dissipation member 720 can be provided.

The fastening member 730 may be inserted through and coupled to the fastening hole 362. This may cause the power supply element 360, the insulation member 710, and the heat dissipation member 720 to be firmly fastened.

A screw thread may be formed on an inner surface of the fastening hole 362. The fastening member 730 being provided as a screw having a thread formed on a side surface may be for stable fastening of the insulation member 710, the power supply element 360, and the heat dissipation member 720.

The fastening hole 362 may communicate with a fastening member housing part 713 and a fastening member insertion hole 714 of the insulation member 710 and a fastening blind hole 723 of the heat dissipation member 720. In an embodiment, the fastening hole 362, the fastening member housing part 713, the fastening member insertion hole 714, and the fastening blind hole 723 may be disposed coaxially.

The connector unit 370 may electrically connect the inverter part 300 and the motor part 400. In detail, the connector unit 370 may electrically connect the printed circuit board 340, the inverter element 350, and the power supply element 360 to the stator 410.

The connector unit 370 may be detachably connected to the inverter part 300 and the motor part 400. To this end, a connector connection part 372 may be formed on one side of the inverter housing 310 facing the main housing 100. The connector unit 370 may be inserted into and coupled to the connector connection part 372.

The motor part 400 may operate according to power and control signals applied from the inverter part 300. The motor part 400 may rotate according to the power and control signals. The rotation of the motor part 400 may be transferred to the compression part 600 to act as a power source for compressing refrigerant.

The motor part 400 may be electrically connected to the inverter part 300 by the connector unit 370. A connector housing part (not shown) may be provided in the motor part 400 so that the connector unit 370 may be electrically connected to the motor part 400.

The motor part 400 may be housed in the main housing 100. In detail, the motor part 400 may be housed in the motor chamber 110 of the main housing 100 such that the outer circumferential surface of the motor part 400 can be brought in contact with the outer circumferential surface of the motor chamber 110, that is, the inner circumferential surface of the main housing 100.

The motor part 400 may be connected to the rotary shaft part 500. In detail, the rotary shaft part 500 may be inserted through and coupled to the motor part 400. When the rotor 420 of the motor part 400 is rotated, the rotary shaft part 500 may be rotated integrally with the rotor 420. This may cause the compression part 600 connected to the rotary shaft part 500 to be rotated to compress refrigerant. The motor part 400 may comprise the stator 410 and the rotor 420.

The stator 410 may form the outside of the motor part 400. The stator 410 may have a cylindrical shape having a circular cross-section and extending lengthwise, that is, in the front-rear direction in the shown embodiment.

A hollow portion passing lengthwise may be formed inside the stator 410. The rotor 420 may be rotatably housed in the hollow portion. The rotor 420 may be spaced a predetermined distance from the stator 410. That is, the outer circumferential surface of the rotor 420 and the inner circumferential surface of the stator 410, that is, the outer circumferential surface of the hollow portion may not be in contact with each other.

The outer circumferential surface of the stator 410 may be brought into contact with the outer circumferential surface of the motor chamber 110, that is, the inner circumferential surface of the main housing 100. The stator 410 may be fixed in the motor chamber 110. Thus, even though the rotor 420 is rotated, the stator 410 may not be rotated.

The stator 410 may be electrically connected to the inverter part 300. A connector housing part (not shown) may be provided in the stator 410. The connector unit 370 may be electrically connected to the connector housing part (not shown).

The stator 410 may comprise a plurality of coils (not shown).

The coils (not shown) may be wound around the stator 410. In an embodiment, the coils (not shown) may be wound around both ends in the length direction of the stator 410, that is, the front and rear ends.

The coils (not shown) may be electrically connected to the connector housing part (not shown). As a result, the coils (not shown) may be electrically connected to the inverter part 300. Power and control signals applied by the inverter part 300 may be transferred to the coils (not shown).

The coils (not shown) may receive the power and control signals to form an electromagnetic field. The electromagnetic field formed by the coils (not shown) may exert an electromagnetic force on a magnet included in the rotor 420. The magnet and the rotor 420 having the rotor may be rotated clockwise or counterclockwise by the electromagnetic force.

The rotor 420 may be rotatably housed in the hollow portion formed inside the stator 410. The rotor 420 may be spaced a predetermined distance from the stator 410. That is, the outer circumferential surface of the rotor 420 and the inner circumferential surface of the stator 410 may not be in contact with each other.

Therefore, the rotor 420 may rotate relative to the stator 410.

The rotor 420 may comprise a plurality of magnets. When power and control signals are applied from the inverter part 300, a plurality of coils (not shown) wound around the stator 410 may form an electromagnetic field. The magnets of the rotor 420 may receive an electromagnetic force by the electromagnetic field and thus rotate clockwise or counterclockwise.

The rotary shaft part 500 may be inserted through and coupled to the rotor 420. When the rotor 420 is rotated, the rotary shaft part 500 may also be rotated integrally with the rotor 420.

The rotary shaft part 500 may transfer a rotational force generated while the motor part 400 is driven to the compression part 600. The compression part 600 may be rotated by the rotation of the rotary shaft part 500 to compress refrigerant.

The rotary shaft part 500 may be coupled to the rotor 420. In detail, the rotary shaft part 500 may be coupled to and rotated integrally with the rotor 420.

The rotary shaft part 500 may be formed to extend lengthwise, that is, in the front-rear direction in the shown embodiment. One side of the rotary shaft part 500 facing the inverter part 300 may be supported by the inverter housing 310. Also, one side of the rotary shaft part 500 facing the compression part 600 may be connected to an orbiting scroll 610 of the compression part 600.

The rotary shaft part 500 may be inserted through and rotatably coupled to a main bearing 560 of a frame part 550. In other words, the rotary shaft part 500 may be rotatably supported by the main bearing 560.

The rotary shaft part 500 may comprise a first end 510, a second end 520, an eccentric part 530, an anti-rotation part 540, the frame part 550, and the main bearing 560.

The first end 510 may be defined as one end of the rotary shaft part 500 adjacent to the inverter part 300. The first end 510 may be rotatably coupled to the inverter housing 310.

A first bearing 512 may be provided in the inverter housing 310 to which the first end is to be coupled. The first bearing 512 may rotatably support the first end 510. Thus, even though the rotary shaft part 500 is rotated, the inverter housing 310 may not be rotated.

The second end 520 may be defined as one end of the rotary shaft part 500 adjacent to the compression part 600. The second end 520 may be coupled to the orbiting scroll 610. When the second end 520, that is, the rotary shaft part 500 is rotated, the orbiting scroll 610 may also be rotated.

In this case, the orbiting scroll may not be rotated by the anti-rotation part 540 and may turn relative to a fixed scroll 620.

A second bearing 522 may be provided in a part of the orbiting scroll 610 to which the second end 520 is to be coupled. The second bearing 522 may be provided in the orbiting scroll 610 and configured not to rotate but to turn when the rotary shaft part 500 is rotated.

In detail, an eccentric part 530 configured to turn the orbiting scroll 610 may be rotatably coupled to the second bearing 522. The eccentric part 530 may be eccentrically coupled to the rotary shaft part 500 and may be rotated integrally with the rotary shaft part 500.

Accordingly, when the rotary shaft part 500 is rotated, the eccentric part 530 may be rotated eccentrically with respect to the rotary shaft part 500. Thus, the orbiting scroll 610 connected to the eccentric part 530 may be turned along with the rotation of the eccentric part 530. In this case, the rotation of the eccentric part 530 may not be transferred to the orbiting scroll 610 by the second bearing 522.

The eccentric part 530 may be coupled to the second end 520 of the rotary shaft part 500 eccentrically with respect to the rotary shaft part 500. When the rotary shaft part 500 is rotated, the eccentric part 530 may also be eccentrically rotated.

Also, the eccentric part 530 may be rotatably coupled to the orbiting scroll 610. The second bearing 522 may be provided at a part where the eccentric part 530 and the orbiting scroll 610 are coupled to each other. Accordingly, by the eccentric rotation of the eccentric part 530, the orbiting scroll may turn instead of rotating.

The anti-rotation part 540 may turnably couple the orbiting scroll 610 to the frame part 550. Also, the anti-rotation part 540 may regulate the orbiting scroll 610 to turn without rotating by the rotational force transferred from the motor part 400.

The anti-rotation part 540 may comprise a pin member 541 and a ring member 542.

The pin member 541 may be formed to extend lengthwise. The pin member 541 may have one side inserted into and coupled to the frame part 550. A pin member insertion hole (not shown) into which the pin member 541 can be inserted may be formed on one side of the frame part 550 facing the orbiting scroll 610.

The pin member insertion hole (not shown) may be fitted to the shape of the pin member 541. When the pin member 541 is inserted into the pin member insertion hole (not shown), the movement of the pin member 541 may be limited to the axial direction, that is, the front-rear direction in the shown embodiment.

The pin member 541 may have other side inserted into and coupled to the ring member 542. The ring member 542 may be housed in the orbiting scroll 610. A pin member insertion hole (not shown) in which the ring member 542 can be housed may be formed on one side of the orbiting scroll 610 facing the frame part 550.

The ring member insertion hole (not shown) may be fitted to the shape of the ring member 542. When the ring member 542 is inserted into the ring member insertion hole (not shown), the movement of the ring member 542 may be limited to the axial direction, that is, the front-rear direction in the shown embodiment.

When the pin member 541 is inserted into the ring member 542, the movement of the orbiting scroll 610 may be limited by the relative movement between the pin member 541 and the ring member 542. In detail, the orbiting scroll 610 may be moved only within the range in which the pin member 541 is movable along the inner circumference of the ring member 542.

Thus, the orbiting scroll 610 may turn without rotating.

The frame part 550 may turnably support the orbiting scroll 610. The frame part 550 may be located between the motor part 400 and the orbiting scroll 610. One side of the frame part 550 facing the orbiting scroll 610 may be in contact with the orbiting scroll 610 and the fixed scroll 620.

In detail, the radially inner side of the one side of the frame part 550 may be in contact with the orbiting scroll 610, and the radially outer side of the one side of the frame part 550 may be in contact with the fixed scroll 620.

The rotary shaft part 500 may be inserted through and coupled to the frame part 550. The main bearing 560 may be provided in the frame part 550, and the rotary shaft part 500 may be rotatably coupled to the main bearing 560. In other words, the main bearing 560 may rotatably support the rotary shaft part 500.

Therefore, even though the rotary shaft part 500 is rotated, the frame part 550 may not be rotated.

The compression part 600 may compress refrigerant introduced into the main housing 100. The compression part 600 may be configured to compress refrigerant by repeating a process of increasing or decreasing a space occupied by the introduced refrigerant.

The compression part 600 may be connected to the rotary shaft part 500. In detail, the orbiting scroll 610 may be connected to the eccentric part 530. When the rotary shaft part 500 is rotated by the motor part 400, the eccentric part 530 may be eccentrically rotated by the rotary shaft part 500.

Along with the rotation of the eccentric part 530, the orbiting scroll 610 connected to the eccentric part 530 may turn relative to the fixed scroll 620.

The compression part 600 may be housed in the main housing 100. In detail, the compression part 600 may be located on one side adjacent to the rear housing in the main housing 100. The compression part 600 may be located between the frame part 550 and the rear housing 200.

In an embodiment, the fixed scroll 620 of the compression part 600 may not be housed in the main housing 100. In the above embodiment, the fixed scroll 620 may be located between the main housing 100 and the rear housing 200 outside the main housing 100.

The compression part 600 may communicate with an inner space of the main housing 100. Refrigerant introduced into the main housing 100 may be introduced into the compression part 600.

The compression part 600 may communicate with an inner space of the rear housing 200. Refrigerant compressed in the compression part 600 may be discharged to the outside of the electric compressor 10 through the rear housing 200.

The compression part 600 may comprise the orbiting scroll 610 and the fixed scroll 620.

The orbiting scroll 610 may turn relative to the fixed scroll 620 by a rotational force generated while the motor part 400 is driven. The turning may cause refrigerant introduced into a space between the orbiting scroll 610 and the fixed scroll 620 to be compressed.

The orbiting scroll 610 may be connected to the motor part 400. In detail, the rotary shaft part 500 connected to the motor part 400 may be connected to the eccentric part 530, and the orbiting scroll 610 may be connected to the eccentric part 530.

When the motor part 400 is driven, the rotary shaft part 500 may be rotated. The eccentric part 530 may be rotated eccentrically with respect to the rotary shaft part 500. In this case, by the eccentric rotation of the eccentric part 530, the orbiting scroll may turn eccentrically with respect to the fixed scroll 620.

One side of the orbiting scroll 610 facing the frame part 550 may be brought into contact with the frame part 550 with a predetermined space formed therebetween. The predetermined space may be defined as a back-pressure chamber S2.

Refrigerant introduced into the back-pressure chamber S2 may apply back pressure to the orbiting scroll 610. That is, refrigerant introduced into the back-pressure chamber S2 may press the orbiting scroll toward the fixed scroll 620.

As the compression of the refrigerant proceeds in the compression part 600, the orbiting scroll 610 may be pressed by the pressure of the compressed refrigerant in a direction opposite to the fixed scroll 620.

When the orbiting scroll 610 is spaced apart from the fixed scroll 620, an end surface of an orbiting wrap 612 and a fixed end plate part 621 may be spaced apart from each other, and an end surface of a fixed wrap 622 and an orbiting end plate part 611 may be spaced apart from each other.

The refrigerant compressed in the orbiting scroll 610 and the fixed scroll 620 may leak through a gap generated due to the separation. As a result, it may be difficult to compress the refrigerant until a desired pressure is reached.

In this case, the compressed refrigerant housed in the back-pressure chamber S2 may press the orbiting scroll 610 toward the fixed scroll 620. Since the back-pressure chamber S2 communicates with a space formed between the orbiting wrap 612 and the fixed wrap 622, the refrigerant housed in the back-pressure chamber S2 may have the same pressure as the compressed refrigerant.

Accordingly, a pressure balance may be achieved between the space between the orbiting wrap 612 and the fixed wrap 622 and the back-pressure chamber S2. Accordingly, the orbiting scroll 610 may remain in contact with the fixed scroll 620, and thus the refrigerant may be effectively compressed without leaking.

A ring member insertion hole (not shown) may be formed on one side of the orbiting scroll 610 facing the frame part 550. The ring member insertion hole (not shown) may be inserted into and coupled to the ring member 542. The pin member 541 may be inserted into the ring member 542 to prevent the rotation of the orbiting scroll 610.

The orbiting scroll 610 may comprise the orbiting end plate part 611, the orbiting wrap 612, and a refrigerant opening 613.

The orbiting end plate part 611 may form the body of the orbiting scroll 610. The orbiting end plate part 611 may be formed in the shape of a disc. One side of the orbiting end plate part 611 may face the frame part 550. The other side of the orbiting end plate part 611 opposite to the one side may face the fixed scroll 620.

The orbiting wrap 612 may be formed to protrude from the other side of the orbiting end plate part 611. The orbiting wrap 612 may be engaged with the fixed wrap 622 of the fixed scroll 620 with a predetermined space formed therebetween.

While the orbiting wrap 612 is engaged with the fixed wrap 622, the orbiting scroll 610 may turn relative to the fixed scroll 620. Thus, refrigerant introduced into the space between the orbiting wrap 612 and the fixed wrap 622 may be compressed by repeatedly expanding and reducing the space.

The orbiting wrap 612 may be spirally formed. The fixed wrap 622 may also be spirally formed, and the orbiting wrap 612 and the fixed wrap 622 may be engaged with each other with a predetermined space formed therebetween.

The refrigerant opening 613 may be a passage through which a portion of the refrigerant compressed in the space between the orbiting wrap 612 and the fixed wrap 622 can be introduced into the back-pressure chamber S2. The refrigerant opening 613 may be formed through the orbiting end plate part 611.

A portion of the refrigerant compressed in the space formed between the orbiting wrap 612 and the fixed wrap 622 may be introduced into the back-pressure chamber S2 through the refrigerant opening 613.

The fixed scroll 620 may be configured to compress refrigerant according to the relative turning movement of the orbiting scroll 610. The fixed scroll 620 may not be rotated irrespective of the rotation of the motor part 400. The outer circumferential surface of the fixed scroll 620 may be fixed to the inner circumferential surface of the main housing 100.

The fixed scroll 620 may communicate with the inside of the main housing 100. The refrigerant introduced into the main housing 100 may be introduced into the space between the orbiting scroll 610 and the fixed scroll 620 via the frame part 550.

The fixed scroll 620 may communicate with the back-pressure chamber S2. A portion of the refrigerant compressed in the space between the orbiting scroll 610 and the fixed scroll 620 may be introduced into the back-pressure chamber S2.

The fixed scroll 620 may communicate with the exhaust flow path 210. A portion of the refrigerant compressed in the space between the orbiting scroll 610 and the fixed scroll 620 may be discharged to the exhaust port 212 through the exhaust flow path 210.

The fixed scroll 620 may be coupled to the rear housing 200 with a predetermined space formed therebetween. The predetermined space may be defined as a discharge chamber S3. The refrigerant compressed in the space between the orbiting scroll 610 and the fixed scroll 620 may be introduced into the exhaust flow path 210 via the discharge chamber S3.

The fixed scroll 620 may comprise the fixed end plate part 621, the fixed wrap 622, a discharge valve 623, and a discharge port 624.

The fixed end plate part 621 may form the body of the fixed scroll 620. The fixed end plate part 621 may be formed in the shape of a disc. One side of the fixed end plate part 621 may face the rear housing 200. The other side of the fixed end plate part 621 opposite to the one side may face the orbiting scroll 610 and the frame part 550.

The fixed wrap 622 may be formed to protrude from the other side of the fixed end plate part 621. The fixed wrap 622 may be engaged with the orbiting wrap 612 of the orbiting scroll 610 with a predetermined space formed therebetween.

While the fixed wrap 622 is engaged with the orbiting wrap 612, the orbiting scroll 610 may turn relative to the fixed scroll 620. Thus, refrigerant introduced into the space between the fixed wrap 622 and the orbiting wrap 612 may be compressed.

The fixed wrap 622 may be spirally formed like the orbiting wrap 612.

The discharge valve 623 may be configured to open or close the discharge port 624. The discharge valve 623 may be provided as a reed valve or the like and may be configured to allow or block a flow of refrigerant from the discharge port 624 to the exhaust flow path 210. The allowance and blocking may be determined according to the pressure of the refrigerant introduced into the discharge port 624.

The discharge port 624 may be a passage through which the refrigerant compressed in the space between the orbiting scroll 610 and the fixed scroll 620 flows toward the exhaust flow path 210. The discharge port 624 may be configured to make the space and the discharge chamber communicate with each other by means of the discharge valve 623.

When the discharge valve 623 is open, the compressed refrigerant may be introduced into the exhaust flow path 210 via the discharge chamber S3 through the discharge port 624. When the discharge valve 623 is closed, the compressed refrigerant may stay in the discharge port 624.

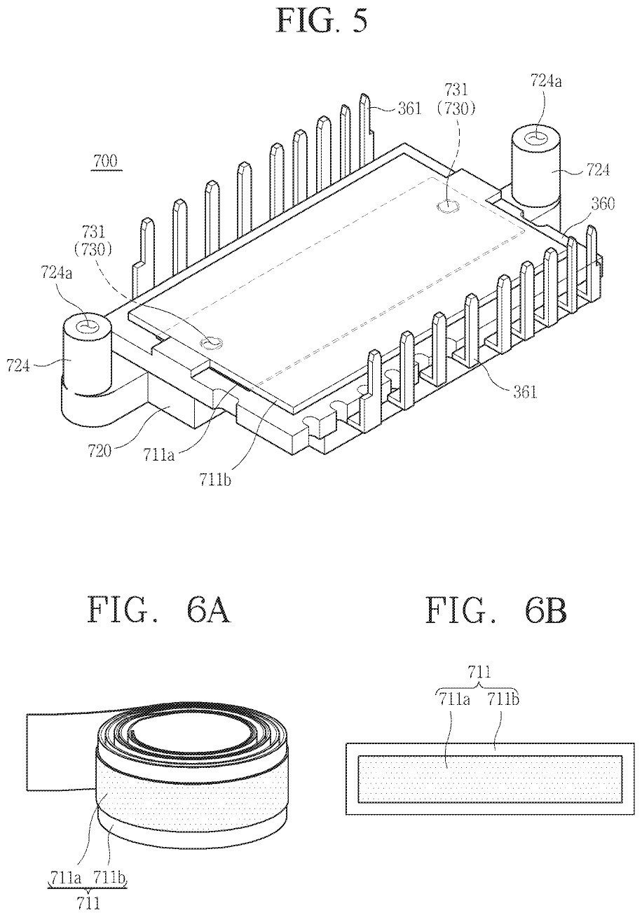

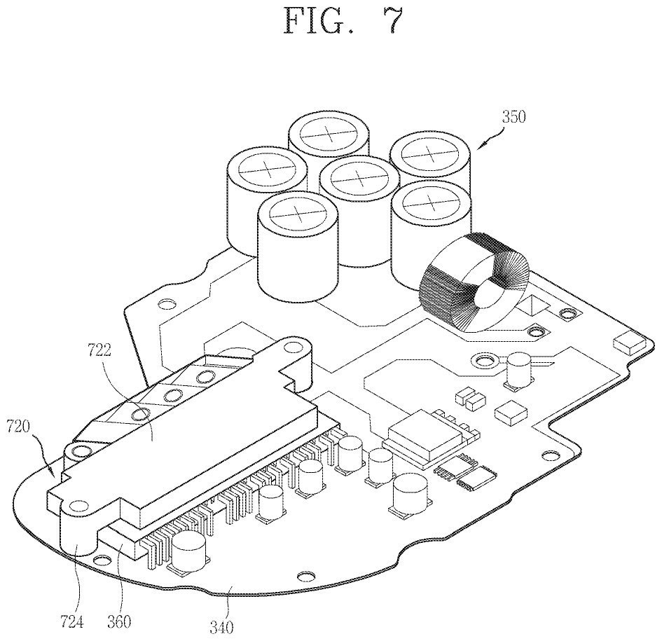

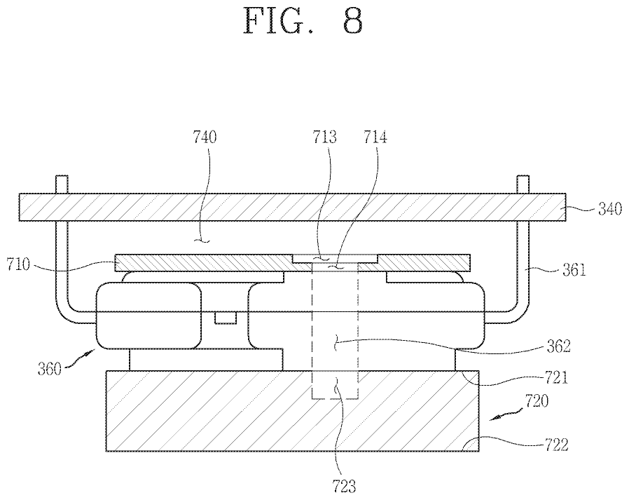

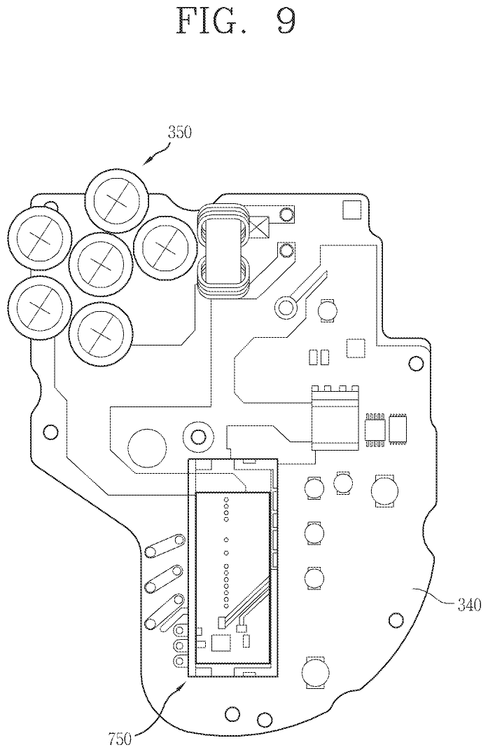

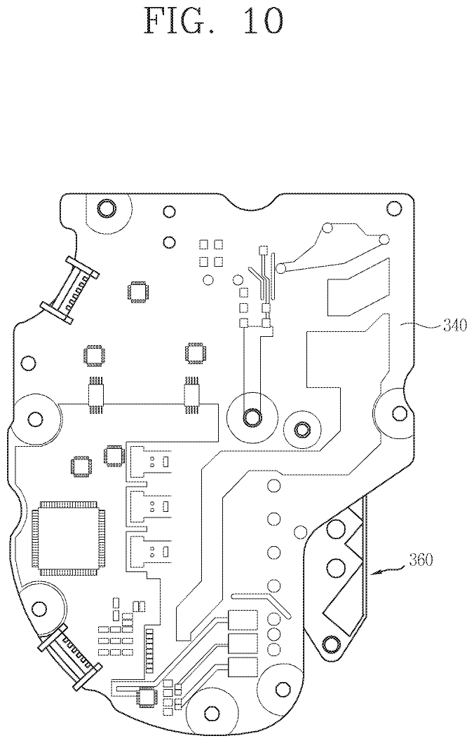

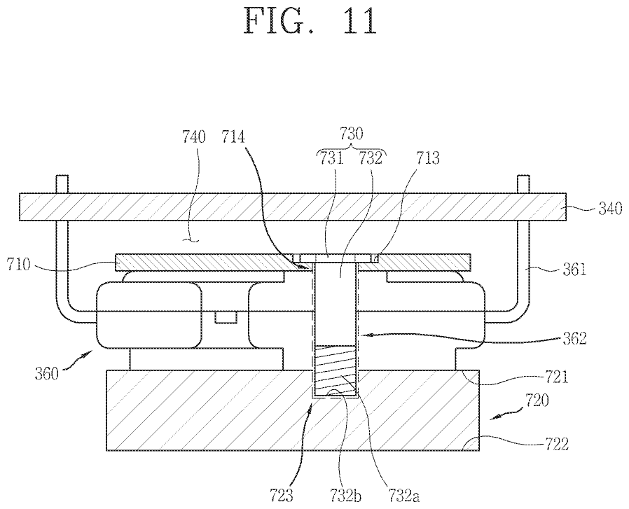

Referring to FIGS. 5 to 11, the electric compressor 10 according to an embodiment of the present disclosure may comprise the insulation part 700.

The insulation part 700 may be provided in the power supply element 360 provided in the inverter chamber S1. The insulation part 700 may prevent electromagnetic noise generated in the power supply element 360 from being transferred to the printed circuit board 340 and the inverter element 350.

Also, since the electromagnetic noise is shielded, the space between the power supply element 360 and the printed circuit board 340 may be defined as the additional element housing part 740 provided in the additional element 750.

The insulation part 700 according to an embodiment of the present disclosure will be described in detail below with reference to FIGS. 5 to 11.

In the shown embodiment, the insulation part 700 may comprise the insulation member 710, the heat dissipation member 720, the fastening member 730, the additional element housing part 740, and the additional element 750.

The insulation member 710 may be configured to electrically shield the power supply element 360 and block electromagnetic noise generated in the power supply element 360.

The insulation member 710 may be provided by attaching to the power supply element 360. In another embodiment, the insulation member 710 may be provided in the shape of a cover and thus may be coupled to the power supply element 360 by covering the power supply element 360.

The insulation member 710 may be located on one side of the power supply element 360 opposite to the inverter housing 310. In other words, the insulation member 710 may be located on one side of the power supply element 360 facing the printed circuit board 340.

Through the arrangement, the insulation member 710 may prevent noise generated in the power supply element 360 from being transferred to the printed circuit board 340, the inverter element 350 electrically connected to the printed circuit board 340, and the like.

The insulation member 710 may be fixed on the one surface of the power supply element 360. This can be accomplished by the fastening member 730 to be described later. Alternatively, the insulation member 710 may be attached to the power supply element 360 in an adhesive manner.

In the shown embodiment, the insulation member 710 may be configured to cover a portion of the one surface of the power supply element 360 facing the printed circuit board 340. In detail, the insulation member 710 may be elongated in the length direction and extending a predetermined distance from a central portion in the width direction of the power supply element 360. Alternatively, the insulation member 710 may be configured to cover the entirety of the one surface.

Insulation member 710 may comprise a first layer 711, a second layer 712, a fastening member housing part 713, and a fastening member insertion hole 714.

The first layer 711 may be configured to absorb noise generated in the power supply element 360. The first layer 711 may be attached to the power supply element 360 and configured to come into direct contact with the power supply element 360. Also, the first layer 711 may be configured to cover one surface of the power supply element 360 facing the printed circuit board 340.

In the shown embodiment, the first layer 711 may be provided in the form of a foil extending lengthwise. Alternatively, the first layer 711 may be in the form of a solid figure shaped according to the shape of the one surface of the power supply element 360.

The first layer 711 may be coupled to the second layer 712. In detail, the other surface opposite to the one surface of the first layer 711 in contact with the power supply element 360 may be coupled to the second layer 712.

The first layer 711 may be formed of a material capable of absorbing noise. In an embodiment, the first layer 711 may be formed of a material such as iron (Fe), copper (Cu), and aluminum (Al).

The first layer 711 may be formed in a rolling or electrolysis manner. Also, in the above embodiment, the first layer 711 may be formed to a thickness of 50 to 300 μm.

The second layer 712 may be configured to physically and electrically shield the first layer 711. Thus, the noise absorbed by the first layer 711 may be prevented by the second layer 712 from being released into the inverter chamber S1.

The noise may be discharged to the outside of the inverter chamber S1 by the fastening member 730 to be described below.

The second layer 712 may be attached to the one surface of the power supply element 360 and may be configured to cover the one surface of the power supply element 360. The second layer 712 may electrically shield the noise absorbed by the first layer 711. Also, the second layer 712 may be configured to insulate heat generated in the power supply element 360.

The second layer 712 may be configured to cover the first layer 711. That is, the first layer 711 may be attached to one surface of the power supply element 360 facing the printed circuit board 340. The second layer 712 may be attached to the one surface of the power supply element 360 and may be configured to cover the first layer 711.

In the shown embodiment, the second layer 712 may be provided in the form of a foil extending lengthwise. Alternatively, the second layer 712 may be in the form of a solid figure shaped according to the shape of the first layer 711 and the shape of the one surface of the power supply element 360.

The extension length in the length direction of the second layer 712 may be greater than the extension length in the length direction of the first layer 711. Also, the width of the second layer 712 may be greater than the width of the first layer 711.

Accordingly, when the second layer 712 is coupled to the first layer 711, one surface of the first layer 711 to which the second layer 712 can be attached may be covered by the second layer 712 and thus prevented from being exposed to the outside.

The second layer 712 may be formed of an insulating material capable of shielding noise. In an embodiment, the second layer 712 may be formed of polyester, vinyl chloride (VC), or the like.

Also, the second layer 712 may be formed of an insulating material. The second layer 712 may thermally shield the power supply element 360 to prevent the heat generated in the power supply element 360 from being released into the inner space of the inverter chamber S1.

The first layer 711 and the second layer 712 may be formed integrally with each other. In an embodiment, the first layer 711 and the second layer 712 may be formed in a laminate manner.

Alternatively, the first layer 711 and the second layer 712 may be provided separately. In the above embodiment, first, the first layer 711 may be attached to one surface of the power supply element 360 facing the printed circuit board 340. Subsequently, the second layer 712 may be attached to the one surface of the power supply element 360 to cover the first layer 711.

When the first layer 711 and the second layer 712 may be attached to the power supply element 360, the first layer 711 and the second layer 712 may be stably fastened to the power supply element 360 and the heat dissipation member 720 by the fastening member 730.

The fastening member housing part 713 may be a space where a head part 731 of the fastening member 730 can be housed. The fastening member housing part 713 may be recessed a predetermined distance from a surface from which the second layer 712 is exposed, that is, the one surface facing the printed circuit board 340.

Alternatively, the fastening member housing part 713 may not be formed. In this case, the head part 731 of the fastening member 730 may be disposed to protrude a predetermined distance in a direction from the second layer 712 to the printed circuit board 340.

The distance and shape of the recess of the fastening member housing part 713 may be determined according to the size and shape of the head part 731 of the fastening member 730.

In the shown embodiment, the fastening member housing part 713 may be formed on one side and the other side in the length direction of the second layer 712. That is, a total of two such fastening member housing parts 713 may be formed. The number and locations of fastening member housing part 713 may be changed.

The fastening member housing part 713 may communicate with the fastening member insertion hole 714.

The fastening member insertion hole 714 may be a space into which the fastening member 730 can be inserted to fasten the power supply element 360, the first layer 711, the second layer 712, and the heat dissipation member 720.

The fastening member insertion hole 714 may be formed through the first layer 711 and the second layer 712. In detail, the fastening member insertion hole 714 may be formed through the first layer 711 and the second layer 712 in a direction in which the first layer 711 and the second layer 712 are stacked.

In the shown embodiment, the fastening member insertion hole 714 may be formed on one side and the other side in the length direction of the first layer 711 and the second layer 712. The locations and number of fastening member insertion holes 714 may be changed to correspond to the locations and number of fastening member housing parts 713.

The fastening member insertion hole 714 may communicate with the fastening blind hole 723 formed in the heat dissipation member 720. Accordingly, one end of the fastening member 730 inserted into the fastening member insertion hole 714, that is, one surface facing the heat dissipation member 720 may be inserted into the fastening blind hole 723.

Accordingly, the power supply element 360 may be grounded to the heat dissipation member 720, and the inverter housing 310 may be configured to come into contact with the heat dissipation member 720 and the main housing 100 by the fastening member 730.

Also, the noise absorbed by the first layer 711 may be released to the heat dissipation member 720, and the inverter housing 310 may be configured to come into contact with the heat dissipation member 720 and the main housing 100 by the fastening member 730.

The heat dissipation member 720 may transfer heat generated in the power supply element 360 to the inverter housing 310 and main housing 100. Thus, the power supply element 360 may be cooled.

The heat dissipation member 720 may be formed of a high thermal conductivity material. In an embodiment, the heat dissipation member 720 may be formed of copper, aluminum, or the like.

The heat dissipation member 720 may be in contact with the power supply element 360. Also, the heat dissipation member 720 may be in contact with the inverter housing 310. Accordingly, heat may be transferred in a direction toward the power supply element 360, the heat dissipation member 720, and the inverter housing 310.

The inverter housing 310 may be in contact with the main housing 100. Accordingly, the heat transferred to the inverter housing 310 may be transferred to the main housing 100. Also, refrigerant may be introduced into the main housing 100. The refrigerant may be brought into contact with the main housing 100 and the inverter housing 310 to cool the transferred heat.

In an embodiment in which the inverter chamber S1 and the main housing 100 communicate with each other, the refrigerant may be directly introduced into the inverter chamber S1. The introduced refrigerant may cool the printed circuit board 340, the inverter element 350, and the like as well as the power supply element 360.

In the shown embodiment, the heat dissipation member 720 may have a rectangular parallelepiped shape extending in the length direction. The heat dissipation member 720 may have any shape capable of being brought into contact with the power supply element 360 and the inverter housing 310.

The heat dissipation member 720 may comprise a first surface 721, a second surface 722, the fastening blind hole 723, and a coupling unit 724.

The first surface 721 may be one surface of the heat dissipation member 720 to be brought into contact with the power supply element 360. The first surface 721 may be defined as one surface of the heat dissipation member 720 facing the power supply element 360.

The first surface 721 may be formed to have the same shape as that of the one surface of the power supply element 360 with which the first surface 721 can be brought into contact.

The second surface 722 may be one surface of the heat dissipation member 720 to be brought into contact with the inverter housing 310. The second surface 722 may be opposite to the first surface 721 and may be defined as one surface of the heat dissipation member 720 facing the inverter housing 310.

In the shown embodiment, the first surface 721 and the second surface 722 may have the same area. Alternatively, the second surface 722 may have a greater area than the first surface 721. In the above embodiment, the heat dissipation member 720 may have a three-dimensional tapered shape having a cross-section area decreasing in a direction from the second surface 722 to the first surface 721.

The fastening blind hole 723 may be a space into which the fastening member 730 inserted into and coupled to the insulation member 710 and the power supply element 360 can be inserted. The fastening blind hole 723 may be formed on the first surface 721 by being recessed therefrom.

The fastening blind hole 723 may have a circular cross section. A thread may be formed on side surfaces forming the fastening blind hole 723. This may be due to the fastening member 730 having a thread formed on an outer circumference and being provided as a thread extending lengthwise, as will be described below.

The fastening blind hole 723 may be disposed coaxially with the fastening hole 362 of the power supply element 360 and the fastening member housing part 713 and the fastening member insertion hole 714.

The sum of the length of the fastening hole 362, the length of the fastening member insertion hole 714, and the recess length of the fastening blind hole 723 may be equal to the extension length of a body part 732 of the fastening member 730.

The coupling unit 724 may be a part at which the heat dissipation member 720 can be coupled to the printed circuit board 340. A coupling hole 724a may be formed through the coupling unit 724.

A coupling member (not shown) for coupling the heat dissipation member 720 and the printed circuit board 340 may be inserted through and coupled to a coupling member engaging part (not shown) formed through the printed circuit board 340 and the coupling hole 72a.

The coupling unit 724 may be located on one side and the other side in the length direction of the heat dissipation member 720. Any number of coupling units 724 may be provided at any locations such that the heat dissipation member 720 and the power supply element 360 brought into contact with the heat dissipation member 720 can be stably coupled to the printed circuit board 340.

The coupling unit 724 may be formed to protrude. In detail, the coupling unit 724 may protrude from the second surface 722 of the heat dissipation member 720 in the length direction of the heat dissipation member 720.

Also, the coupling unit 724 may protrude toward the printed circuit board 340. The coupling unit 724 may be configured to adjust the distance between the printed circuit board 340 and the power supply element 360. Even when the heat dissipation member 720 is coupled to the printed circuit board 340, the power supply element 360 and the printed circuit board 340 may not be brought into contact with each other due to the protrusion of the coupling unit 724.

A space formed by the power supply element 360 and the printed circuit board 340 spaced apart from each other by the coupling unit 724 may be defined as the additional element housing part 740. The additional element 750 may be housed in the additional element housing part 740.

The fastening member 730 may fasten the insulation member 710, the power supply element 360, and the heat dissipation member 720. The fastening member 730 may be inserted through the insulation member 710 and the power supply element 360. Also, the fastening member 730 may be inserted into the heat dissipation member 720

The fastening member 730 may be provided in any form capable of fastening two or more members. In the shown embodiment, the fastening member 730 may be provided in the form of a screw having a thread formed on a side surface 723a. Alternatively, the fastening member 730 may be provided as a rivet or the like.

The fastening member 730 may comprise the head part 731 and the body part 732.

The head part 731 may form an upper side of the fastening member 730. The head part 731 may have a greater cross section than the body part 732. When the fastening member 730 is coupled to the insulation member 710, the power supply element 360, and the heat dissipation member 720, the head part 731 may be housed in the fastening member housing part 713 formed on the second layer 712.

The height of the head part 731 may be equal to the recession distance of the fastening member housing part 713. In the above embodiment, when the fastening member 730 is fastened, the head part 731 may not protrude from the second layer 712.

The body part 732 may be a part that is inserted into and coupled to the fastening member insertion hole 714, the fastening hole 362, and the fastening blind hole 723. The body part 732 may be formed to extend lengthwise.

The head part 731 may be located on one end of the body part 732.

The other end 732b of the body part 732 opposite to the one end may be in contact with the bottom surface of the fastening blind hole 723.

A screw thread may be formed on the side surface 732a of the body part 732. In the above embodiment, the fastening member 730 may be screwed into the fastening hole 362 and the fastening blind hole 723.

When the fastening member 730 is inserted into the fastening member insertion hole 714, the fastening hole 362, and the fastening blind hole 723, the fastening member 730 may be brought into contact with the first layer 711, the power supply element 360, and the heat dissipation member 720. Therefore, heat, electric current, and noise may be transferred from the first layer 711, the power supply element 360, and the heat dissipation member 720 to the fastening member 730.

The fastening member 730 may be formed of a high thermal conductivity material. Accordingly, heat generated in the power supply element 360 may be dissipated through the fastening member 730 as well as through direct contact with the heat dissipation member 720.

The fastening member 730 may be formed of a high electrical conductivity material. Therefore, the power supply element 360 may be grounded by the fastening member 730 without an additional member. Also, noise collected in the first layer 711 may be discharged to the inverter housing 310 and the main housing 100 through the fastening member 730.

The additional element housing part 740 may be a space where the additional element 750 is provided between the printed circuit board 340 and the power supply element 360. The additional element housing part 740 may be defined by a space formed by the printed circuit board 340 and the power supply element 360 facing each other.

As described above, the electric compressor 10 according to an embodiment of the present disclosure may comprise the insulation member 710 configured to shield noise generated in the power supply element 360. The insulation member 710 may be configured to cover one surface of the power supply element 360 facing the printed circuit board 340.

Noise generated while the power supply element 360 is operated may be absorbed by the first layer 711 of the insulation member 710. Also, since the first layer 711 may be shielded by the second layer 712, the absorbed noise does not travel toward the printed circuit board 340.

That is, the additional element housing part 740 may be a region that is not affected by the noise generated by the power supply element 360. Accordingly, the additional element 750 may be provided in the additional element housing part 740.

In the shown embodiment, the additional element 750 may be provided in the form of a printed circuit board. The additional element 750 may be provided in any form capable of performing the function of the printed circuit board 340 or the inverter element 350.

Also, the additional element 750 may be electrically connected to the connector module 330, the printed circuit board 340, and the inverter element 350.

That is, when the additional element 750 is provided, it may be possible to increase the capacity of the printed circuit board 340 or the inverter element 350 which has been provided may be increased.

Accordingly, even when high-voltage power is applied, the printed circuit board 340 and the inverter element may have sufficient capacity by means of the additional element 750. Therefore, it may be possible to cope with a high-voltage power source without increasing the size of the printed circuit board 340 or the inverter element 350 itself.

The inverter part 300 of the electric compressor 10 according to an embodiment of the present disclosure may comprise the printed circuit board 340, the inverter element 350, and the power supply element 360.

The insulation member 710 may be provided on one surface of the power supply element 360 facing the printed circuit board 340. The insulation member 710 may be configured to electrically shield the power supply element 360. Noise generated in the power supply element 360 may be shielded by the insulation member 710 and prevented from being introduced into the inverter chamber S1.

Thus, the space between the printed circuit board 340 and the power supply element 360, that is, the additional element housing part 740 may not be affected by the noise generated in the power supply element 360. Accordingly, the additional element 750 may be provided in the additional element housing part 740.

The additional element 750 may be provided in any form capable of performing the same function as that of the printed circuit board 340 or the inverter element 350. Also, the additional element 750 may be electrically connected to the printed circuit board 340, the inverter element 350, and the like.

Accordingly, When the capacity of the printed circuit board 340 or the inverter element 350 is required in response to the high-voltage power source, it may be possible to expand the capacity of the printed circuit board 340 or the inverter element 350 by including the additional element 750 without increasing the size of the printed circuit board 340 or the inverter element 350 itself.

Also, the additional element housing part 740 may be formed in a space between the printed circuit board 340 and the power supply element 360. According to the related art, the space may be a kind of dead space in which no electronic devices or the like can be provided due to the noise of the power supply element 360.

The electric compressor 10 according to an embodiment of the present disclosure may block noise from being transferred to the space through the insulation part 700. Accordingly, since the additional element 750 is disposed in a space that was not usable conventionally, it may be possible to improve space utilization in the inverter chamber S1.

Furthermore, since the additional element 750 can be disposed in the existing space, there may be no need to change the internal design of the inverter part 300 to ensure a space for placing the additional element 750.

The first layer 711 and the second layer 712 constituting the insulation member 710 may be provided in the form of a foil. Accordingly, even when the insulation member 710 is stacked on the power supply element 360, it may be possible to minimize the size reduction of the additional element housing part 740. Thus, it may be possible to improve diversity of selection of an additional element 750 to be provided in the additional element housing part 740.

The fastening member 730 may fasten the insulation member 710, the heat dissipation member 720, and the power supply element 360. In addition, the fastening member 730 may be configured to come into contact with the first layer 711 of the insulation member 710, the inner circumferential surface of the fastening blind hole 723 of the heat dissipation member 720, and the inner circumferential surface of the fastening hole 362 of the power supply element 360.

Accordingly, the power supply element 360 may be electrically connected to the heat dissipation member 720 and the main housing 100 brought into contact with the heat dissipation member 720. Thus, it may be possible to ground the power supply element 360 without a separate wiring structure.

Also, the fastening member 730 may be electrically connected to the first layer 711. Noise absorbed by the first layer 711 may be discharged to the outside of the inverter chamber S1 through the fastening member 730.

Furthermore, the fastening member 730 may receive heat from the power supply element 360. Accordingly, heat may be dissipated from the power supply element 360 by the fastening member 730 as well as by the heat dissipation member 720. Therefore, it may be possible to improve the heat dissipation efficiency of the fastening member 730.

The foregoing description has been given of the preferred embodiments, but it will be apparent to those skilled in the art that various modifications and variations can be made in the present disclosure without departing from the spirit or scope of the disclosure as defined in the appended claims.

What is claimed is:

1. An electric compressor comprising:
a compression part comprising a fixed scroll and an orbiting scroll configured to orbit relative to the fixed scroll to compress refrigerant;
a motor part coupled to the compression part and configured to apply a rotational force to the compression part; and
an inverter part electrically coupled to the motor part and configured to apply power and control signals to the motor part,
wherein:
the inverter part comprises:
a power supply element housed therein and configured to apply power to the motor part; and
a printed circuit board (PCB) electrically coupled to the power supply element and configured to apply a control signal to the motor part, and
an insulation member is located on one side of the power supply element adjacent to the PCB, the insulation member being configured to shield the one side of the power supply element and prevent noise generated in the power supply element from reaching the PCB.

2. The electric compressor of claim 1, wherein the insulation member comprises:
a first layer formed of a conductive material, wherein the first layer is configured to be brought into contact with the insulation member; and
a second layer formed of a non-conductive material, wherein the second layer is configured to cover the first layer.

3. The electric compressor of claim 1, wherein,
the power supply element and the PCB are electrically coupled to each other with a predetermined space formed therebetween, and
an additional element is located in the predetermined space, wherein the additional element is configured to be electrically connected to the PCB.

4. The electric compressor of claim 3, wherein the additional element comprises an additional PCB.

5. The electric compressor of claim 1, further comprising a main housing configured to house the compression part and the motor part,
wherein:
the inverter part comprises:
an inverter housing having one side coupled to the main housing; and
an inverter cover coupled to the inverter housing with a predetermined space formed therein, and
the PCB, the power supply element, and the insulation member are housed in the predetermined space.

6. The electric compressor of claim 5, further comprising a heat dissipation member located between the power supply element and the inverter housing, wherein the heat dissipation member is configured to come into contact with the power supply element and the inverter housing to transfer heat generated in the power supply element to the inverter housing.

7. The electric compressor of claim 6, wherein the heat dissipation member is formed of a conductive material.

8. The electric compressor of claim 6, further comprising a fastening member extending lengthwise and configured to fasten the insulation member, the power supply element, and the heat dissipation member.

9. The electric compressor of claim 8, wherein:
the fastening member is configured to be inserted through and coupled to the insulation member and the power supply element, and
the fastening member is configured to be inserted into and coupled to the heat dissipation member.

10. The electric compressor of claim 8, wherein:
a side surface of the fastening member fastened to the power supply element is configured to be brought into electrical contact with the power supply element, and
one end of the fastening member fastened to the heat dissipation member is configured to be brought into electrical contact with the heat dissipation member.

11. The electric compressor of claim 10, wherein the heat dissipation member and the inverter housing are configured to be brought into electrical contact with each other.

12. The electric compressor of claim 8, wherein the fastening member comprises:
a head part forming one end facing the PCB; and
a body part extending from the head part, wherein another end of the body part opposite to the head part is configured to be inserted into the heat dissipation member.

13. The electric compressor of claim 12, wherein the insulation member comprises a fastening member insertion hole, and wherein the fastening member insertion hole is recessed a predetermined distance and configured to accommodate the head part of the fastening member.

14. The electric compressor of claim 8, wherein:
the power supply element further comprises a fastening hole,
the heat dissipation member further comprises a coupling hole, the coupling hole being recessed a predetermined distance, and
the fastening member is configured to be inserted through and coupled to the fastening hole and is configured to be inserted into and coupled to the coupling hole.

15. The electric compressor of claim 6, further comprising a connector part configured to electrically couple the inverter part and the motor part.

16. An electric compressor comprising:
a main housing configured to enclose:
a compression part comprising a fixed scroll and an orbiting scroll configured to orbit relative to the fixed scroll; and
a motor part coupled to the compression part and configured to apply a rotational force to the compression part; and
an inverter part electrically coupled to the motor part and configured to apply power and control signals to the motor part,
wherein:
the inverter part comprises:
a power supply element;
a printed circuit board (PCB) electrically coupled to the power supply element;
an inverter housing having one side coupled to the main housing; and
an inverter cover coupled to the inverter housing, and
an insulation member located on one side of the power supply element adjacent to the PCB, the insulation member being configured to contact the one side of the power supply element.

17. The electric compressor of claim 16, wherein:
the inverter cover includes a space formed therein, and
the PCB, the power supply element, and the insulation member are housed in the space.

18. The electric compressor of claim 16, wherein the insulation member is configured to prevent electromagnetic noise generated in the power supply element from being transferred to the PCB.

19. The electric compressor of claim 16, further comprising a connection pin configured to electrically connect the power supply element and the PCB, wherein the connection pin extends toward the PCB.

20. An electric compressor comprising:
a main housing configured to enclose:
a compression part comprising a fixed scroll and an orbiting scroll configured to orbit relative to the fixed scroll; and
a motor part coupled to the compression part and configured to apply a rotational force to the compression part; and
an inverter part electrically coupled to the motor part and configured to apply power and control signals to the motor part,
wherein:
the inverter part comprises:
a power supply element;
a printed circuit board (PCB) electrically coupled to the power supply element;
an inverter housing having one side coupled to the main housing; and
an inverter cover coupled to the inverter housing, and
a heat dissipation member formed of a conductive material located between the power supply element and the inverter housing, the heat dissipation member being configured to contact the power supply element and the inverter housing.
